(19) United States
(12) Patent Application Publication
(10) Pub. No.: US 2020/0084855 A1
(43) Pub. Date: Mar. 12, 2020

(54) Customized Photometric Data For Lighting System Designs

(71) Applicant: Eaton Intelligent Power Limited, Dublin 4 (IE)

(72) Inventors: Gregory Parker, Denver, CO (US); Adam Foy, Parker, CO (US)

(21) Appl. No.: 16/129,541

(22) Filed: Sep. 12, 2018

(51) Int. Cl. H05B 33/08; H05B 37/02; H05B 39/04

(52) U.S. Cl. CPC H05B 33/0863; H05B 39/042; H05B 37/0245

(57) ABSTRACT

A photometric data tool can include an interface and a controller coupled to the interface. The controller can receive multiple inputs, via the interface, where the inputs are associated with a proposed customized light fixture, where the inputs include a length of the customized light fixture. The controller can also retrieves, by a photometric data generator using the plurality of inputs, historical photometric data for at least one other light fixture having at least one characteristic in common with the customized light fixture. The controller can further generates, by the photometric data generator using the historical photometric data, photometric data for the customized light fixture. The controller can also present the photometric data for the customized light fixture.

### TECHNICAL FIELD

Embodiments described herein relate generally to lighting system designs, and more particularly to systems, methods, and devices for customized photometric data for designing lighting systems.

### BACKGROUND

When installing equipment (e.g., a lighting system, a security system, fencing, a house), a certain amount of planning must go into the process before the installation work can begin. Part of the planning process involves understanding the existing infrastructure, understanding applicable standards and codes, determining the equipment that can be used, and determining the price of the equipment that is selected for installation. Another part of the process is understanding the most effective light fixtures to use at certain locations and in certain circumstances. While this information can be readily available for standard fixtures, such information about customized or other non-standard fixtures is not readily available.

### SUMMARY

In general, in one aspect, the disclosure relates to a photometric data tool that includes an interface and a controller coupled to the interface. The controller of the photometric data tool can receive multiple inputs, via the interface, where the inputs are associated with a proposed customized light fixture, where the inputs include a length of the customized light fixture. The controller of the photometric data tool can also retrieve, by a photometric data generator using the inputs, historical photometric data for at least one other light fixture having at least one characteristic in common with the customized light fixture. The controller of the photometric data tool can further generate, by the photometric data generator using the historical photometric data, photometric data for the customized light fixture. The controller of the photometric data tool can also present the photometric data for the customized light fixture.

In another aspect, the disclosure can generally relate to a computer readable medium comprising computer readable program code embodied therein for a method for generating photometric data for a customized light fixture using a photometric data tool. The method can include receiving multiple inputs, via an interface of the photometric data tool, where the inputs are associated with a proposed customized light fixture, where the inputs comprises a length of the customized light fixture. The method can also include retrieving, by a photometric data generator using the inputs, historical photometric data for at least one other light fixture having at least one characteristic in common with the customized light fixture. The method can further include generating, by the photometric data generator using the historical photometric data, photometric data for the customized light fixture. The method can also include presenting the photometric data for the customized light fixture.

These and other aspects, objects, features, and embodiments will be apparent from the following description and the appended claims.

### BRIEF DESCRIPTION OF THE DRAWINGS

The drawings illustrate only example embodiments of customized photometric data for lighting system designs and are therefore not to be considered limiting of its scope, as customized photometric data for lighting system designs may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a volume of space subject to an installation.

FIG. 2 shows a diagram of a system in accordance with certain example embodiments.

FIG. 3 shows a computing device in accordance with one or more example embodiments.

FIG. 4 shows an interface used to generate photometric data in accordance with certain example embodiments.

FIGS. 5A through 8C show various tables of historical photometric data in accordance with certain example embodiments.

FIGS. 9 and 10 show graphs of photometric data in accordance with certain example embodiments.

FIG. 11 shows a flowchart of a method for generating photometric data in accordance with certain example embodiments.

### DETAILED DESCRIPTION OF EXAMPLE EMBODIMENTS

The example embodiments discussed herein are directed to systems, apparatuses, and methods of customized photometric data for lighting system designs, which can include functionality for configuring, mapping, evaluating, planning, budgeting, ordering, scheduling, and performing any other function associated with installation of new or retrofitted lighting systems. While example embodiments described herein are directed to use with installing lighting systems, example embodiments can also be used for installing any other systems and/or equipment that include at least one light fixture.

In certain example embodiments, at least one of the light fixtures for which estimates are generated is a customized light fixture that is not normally manufactured aside from special orders or small batch orders. For example, linear light fixtures can be made to custom lengths and/or have a number of other custom features (e.g., type of light source, lumen output, correlated color temperature). Examples of such other systems and/or equipment can include, but are not limited to, fire protection systems, security systems, and furniture. Thus, example embodiments are not limited to use with only lighting systems. Example embodiments can be used for installations that occur indoors, outdoors, or a combination thereof.

In the foregoing figures showing example embodiments of customized photometric data for lighting system designs, one or more of the components shown may be omitted, repeated, and/or substituted. Accordingly, example embodiments of customized photometric data for lighting system designs should not be considered limited to the specific arrangements of components shown in any of the figures. For example, features shown in one or more figures or described with respect to one embodiment can be applied to another embodiment associated with a different figure or description. Further, any description of a figure or embodiment made herein stating that one or more components are not included in the figure or embodiment does not mean that such one or more components could not be included in the figure or embodiment, and that for the purposes of the claims set forth herein, such one or more components can be included in one or more claims directed to such figure or embodiment.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three or four digit number and corresponding components in other figures have the identical last two digits.

In certain example embodiments, the systems (or portions thereof) that are subject to design and/or installation described herein must comply with one or more of a number of standards, codes, regulations, and/or other requirements established and maintained by one or more entities. Examples of such entities include, but are not limited to, the Illuminating Engineering Society (IES), Underwriters' Laboratories (UL), the National Electric Code (NEC), the California Energy Commission (CEC), the Institute of Electrical and Electronics Engineers (IEEE), the Federal Communication Commission (FCC), and the National Fire Protection Association (NFPA). For example, light fixtures installed in a volume of space are subject to compliance with one or more standards set forth in the NEC.

Example embodiments of customized photometric data for lighting system designs will be described more fully hereinafter with reference to the accompanying drawings, in which example embodiments of customized photometric data for lighting system designs are shown. Customized photometric data for lighting system designs may, however, be embodied in many different forms and should not be construed as limited to the example embodiments set forth herein. Rather, these example embodiments are provided so that this disclosure will be thorough and complete, and will fully convey the scope of customized photometric data for lighting system designs to those of ordinary skill in the art. Like, but not necessarily the same, elements (also sometimes called components) in the various figures are denoted by like reference numerals for consistency.

Terms used herein such as, but not limited to, “top”, “bottom”, “left”, “right”, “first”, and “second” are used merely to distinguish one component (or part of a component or state of a component) from another. Such terms are not meant to denote a preference or a particular orientation, and are not meant to limit embodiments of customized photometric data for lighting system designs. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

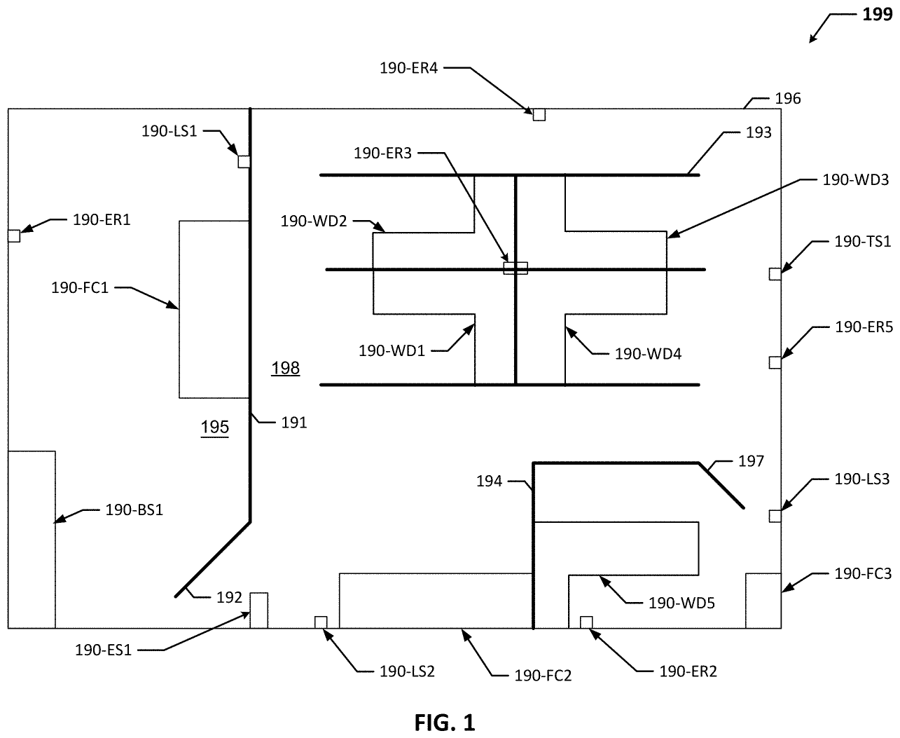

FIG. 1 shows a volume of space 199 that is subject to design for installation of a lighting system. Specifically, the volume of space 199 of FIG. 1 is part of an office building. There are a number of elements that define and/or are disposed within the volume of space 199. These elements include equipment 190 that can be electrical devices or non-electrical devices. Among the equipment 190 that are non-electrical devices, there are three file cabinets 190-FC (file cabinet 190-FC1, file cabinet 190-FC2, and file cabinet 190-FC3), five work desks 190-WD (work desk 190-WD1, work desk 190-WD2, work desk 190-WD3, work desk 190-WD4, and work desk 190-WD5), and a book shelf 190-B51.

Among the equipment 190 that are electrical devices, there are five electrical receptacles 190-ER (electrical receptacle 190-ER1, electrical receptacle 190-ER2, electrical receptacle 190-ER3, electrical receptacle 190-ER4, and electrical receptacle 190-ER5), a thermostat 190-TS1, three light switches 190-LS (light switch 190-LS1, light switch 190-LS2, and light switch 190-LS3), and an exit sign 190-ES1.

These elements also include a number of walls (in this case, wall 191, wall 193, wall 194, and wall 196) and two doors (door 192, door 197). Wall 196 defines the outer perimeter of the volume of space 199. The volume of space 199 is divided into a number of areas. For example, wall 191 and door 192 separate a hallway 192 (in which electrical receptacle 190-ER1, light switch 190-LS1, file cabinet 190-FC1, and book shelf 190-BS1 are located) from a work space 198 (in which the remainder of the equipment 190 is located). The exit sign 190-ES1 is located above the door 192 within the work space 198.

Wall 194 and door 197 define an office (in which electrical receptacle 190-ER2, light switch 190-LS3, file cabinet 190-FC3, and work desk 190-WD5 are located) within the work space 198. In addition, a number of cubicle walls 193 are located within the work space 198 outside of the office. As FIG. 1 shows, there are no light fixtures in the volume of space 199. Example embodiments can be used to interactively customize photometric data to design, budget, order, and schedule the work needed to install a lighting system in the volume of space 199.

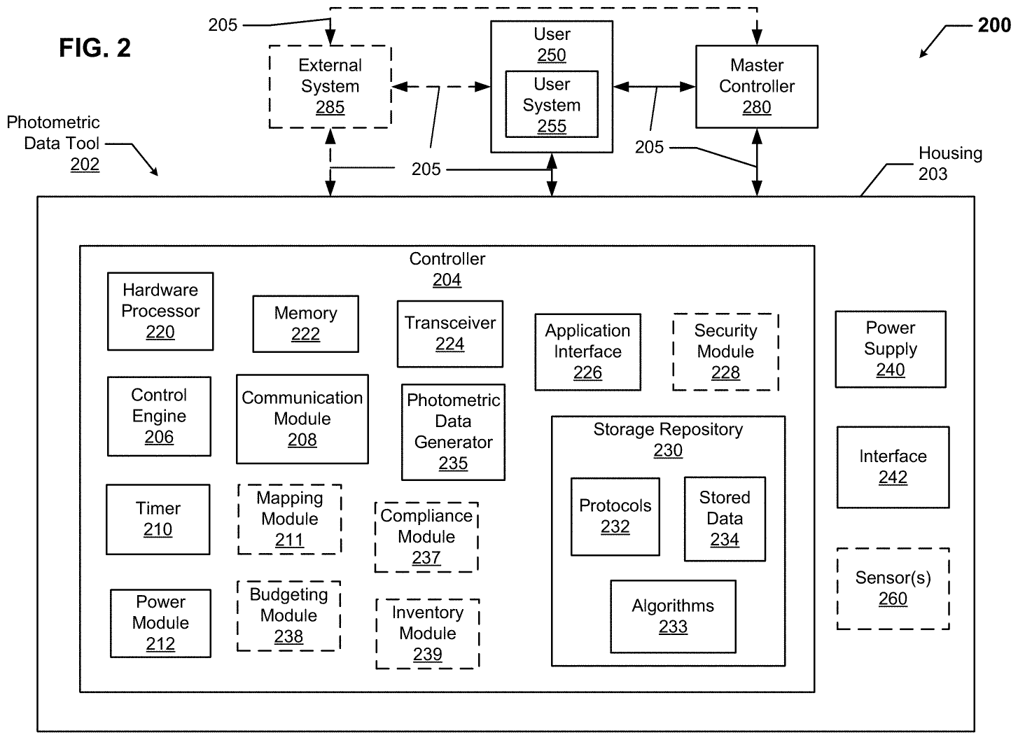

FIG. 2 shows a diagram of a system 200 that includes a photometric data tool 202 in accordance with certain example embodiments. The system 200 can include a user 250, a master controller 280, and one or more optional external system 285. In addition, the photometric data tool 202 can include a controller 204, a power supply 240, an interface 242, and one or more optional sensors 260 (also sometimes called sensor modules 260 or sensor devices 260).

The controller 204 can include one or more of a number of components. Such components, can include, but are not limited to, a control engine 206, a communication module 208, a timer 210, a photometric data generator 235, an optional mapping module 211, an optional compliance module 237, an optional budgeting module 238, an optional inventory module 239, a power module 212, a storage repository 230, a hardware processor 220, a memory 222, a transceiver 224, an application interface 226, and, optionally, a security module 228. The components shown in FIG. 2 are not exhaustive, and in some embodiments, one or more of the components shown in FIG. 2 may not be included in an example photometric data tool 202. Any component of the example photometric data tool 202 can be discrete or combined with one or more other components of the photometric data tool 202.

A user 250 can be any person that interacts with the installation of lighting systems and/or other systems and equipment that can be installed or retrofitted and include at least one light fixture. Examples of a user 250 can include, but are not limited to, a consumer, an electrician, an engineer, a mechanic, a lighting engineer, a lighting technician, a lighting designer, a lighting programmer, an instrumentation and control technician, a consultant, a contractor, an operator, a landscape designer, a sales person, a construction engineer, a landowner, a landlord, a tenant, and a manufacturer's representative.

The user 250 can use a user system 255, which may include a display (e.g., a GUI), some other interface (e.g., a mouse, a keyboard, a pushbutton), and/or an optional controller, such as the controller 204 of the photometric data tool 202 described below. The user system 255 of the user 250 interacts with (e.g., sends data to, receives data from) the controller 204 of the photometric data tool 202 via the application interface 226 (described below). The user system 255 of the user 250 can also interact with the master controller 280 and/or any of the optional external systems 285 in the system 200. In some cases, the photometric data tool 202 can be software loaded onto the user system 255. In other cases, the photometric data tool 202 can be a cloud-based application that can be accessible on a user system 255. Examples of a user system 255 can include, but are not limited to, a remote control, a hand-held transmitter, a personal computer (PC), a laptop, and a mobile phone.

Interaction between the user system 255 of the user 250, the photometric data tool 202 (or components thereof, such as the controller 204), an optional external system 285, and/or the master controller 280 is conducted using communication links 205. Each communication link 205 can include wired (e.g., Class 1 electrical cables, Class 2 electrical cables, electrical connectors, power line carrier, DALI, RS485) and/or wireless (e.g., Wi-Fi, visible light communication, cellular networking, UART, SPI, I2C, visible light communication (VLC), 802.15.4 wireless, ZigBee, 4G cellular wireless, Bluetooth, WirelessHART, ISA100) technology. For example, a communication link 205 can be (or include) one or more electrical conductors that are coupled to the optional housing 203 of the photometric data tool 202. The communication link 205 can transmit signals (e.g., power signals, communication signals, control signals, data) between the photometric data tool 202, the optional external systems 285, the user system 255 of the user 250, and/or the master controller 280.

The master controller 280 is a device or component that controls all or a portion of a communication network that includes the controller 204 of the photometric data tool 202 and the optional external systems 285 (including components thereof) that are communicably coupled to the controller 204. The master controller 280 can be substantially similar to the controller 204. Alternatively, the master controller 280 can include one or more of a number of features in addition to, or altered from, the features of the controller 204 described below. For example, the master controller 280 can include a storage repository that holds a multitude of photometric data. As described herein, communication with the master controller 280 can include communicating with one or more other components (e.g., another photometric data tool 202) of the system 200 or another system. In such a case, the master controller 280 can facilitate such communication.

As shown in FIG. 2, the system 200 can include one or more of a number of optional external systems 285. An optional external system 285 is a source of information that is external to the photometric data tool 202. Such information provided by an external system 285 can be used, at least in part, in evaluating, preparing for, and/or generating photometric data for a customized light fixture. Examples of an external system 285 can include, but are not limited to, a custom light fixture manufacturer, a standard light fixture manufacturer, an inventory management system, a regulatory database, a code authority, a price management system, a workforce scheduling system, a supplier network, a transportation scheduling system, forecasting tools, a bank, another photometric data tool, and a construction engineering database.

Examples of information that can be provided by an optional external system 285 can include, but is not limited to, historical (e.g., previously-tested, previously-forecast) photometric data, available inventory, available products, available workforce, costs, regulatory requirements, code requirements, the existence, location, and/or layout of existing equipment and systems, dimensions of a volume of space, location of easements and common areas, and a prediction of cost savings or a cost comparison over time. One or more external systems 285 can provide some or all of the historical photometric data used by the photometric data tool 202 to generate photometric data for a customized light fixture. The photometric data tool 202 can actively request and receive from an appropriate external system 285 various information needed to implement some stage (e.g., planning, scheduling, executing) of installation.

The one or more optional sensors 260 of the photometric data tool 202 can be any type of sensing device that measures one or more parameters. Examples of types of sensors 260 can include, but are not limited to, a passive infrared sensor, a photocell, a microphone, a pressure sensor, a proximity sensor, a SONAR sensor, a LIDAR sensor, a seismic sensor, a camera, a global positioning system, and an air flow monitor. A parameter that can be measured by a sensor 260 can include, but is not limited to, motion, hand gestures by a user 250, movements of the head of a user 250, sound, facial features, distance, light, and time.

In some cases, the parameter or parameters measured by a sensor 260 can be used by the photometric data tool 202 to receive measurements, instructions, and/or requests relative to planning for an installation. For example, a sensor 260 can include a microphone and voice-to-text software so that the sensor 260 can recognize and act on verbal statements (e.g., questions, inputs) made by the user system 255 of the user 250. As another example, a sensor 260 can include a camera that detects objects in a volume of space and can measure the size (e.g., dimensions) and precise location of each object in the volume of space, and these measurements can be used as a direct input into one or more modules (e.g., the photometric data generator 235, the mapping module 211) of the photometric data tool 202.

Each sensor 260 can use one or more of a number of communication protocols. A sensor 260 can be associated with an external system 285 and/or the interface 242 in the system 200. A sensor 260 can be located within the housing 203 of the photometric data tool 202, disposed on the housing 203 of the photometric data tool 202, or located outside the housing 203 of the photometric data tool 202. A sensor 260 can be part of, or separate from, the controller 204. In certain example embodiments, a sensor 260 can include a battery that is used to provide power, at least in part, to some or all of the rest of the sensor 260.

The interface 242 can be a component of the photometric data tool 202 that actively receives one or more inputs from and, in some cases, provides an output (photometric data) to the user system 255 of the user 250 and/or some other component of the system 200, including another component (e.g., an optional sensor 260, the photometric data generator 235) of the photometric data tool 202. The interface 242 can be physical and/or virtual. The interface 242 can be used, for example, when the photometric data tool 202 is a stand-alone device. Examples of such an interface 242 can include, but are not limited to, a touch screen, a display, a mouse, a keyboard, a stylus, a printer, a USB port, and a speaker. In some cases, such as when the interface 242 is virtual, the interface 242 can be integrated with one or more sensors 260 (e.g., a microphone with voice recognition software, a camera with software recognizing specific gestures, a measurement device that can capture measurements of an object or a volume of space).

The power supply 240 of the photometric data tool 202 can provide power to one or more of the optional sensors 260, the interface 242, and the power module 212 of the controller 204. The power supply 240 can be substantially the same as, or different than, the power module 212 (described below) of the controller 204. The power supply 240 can include one or more of a number of single or multiple discrete components (e.g., transistor, diode, resistor), and/or a microprocessor. The power supply 240 may include a printed circuit board, upon which a microprocessor and/or one or more discrete components are positioned.

The power supply 240 can include one or more components (e.g., a transformer, a diode bridge, an inverter, a converter) that receives power (for example, through an electrical cable) from a source external to the photometric data tool 202 and generates power of a type (e.g., alternating current, direct current) and level (e.g., 12V, 24V, 120V) that can be used by the optional sensors 260, the interface 242, and/or the power module 212. In addition, or in the alternative, the power supply 240 can receive power from the power module 212 of the controller 204. In addition, or in the alternative, the power supply 240 can be a source of power in itself. For example, the power supply 240 can include a battery, a localized photovoltaic power system, and/or some other source of independent power.

The user system 255 of the user 250, the master controller 280, and/or the optional external systems 285 can interact with the controller 204 of the photometric data tool 202 using the application interface 226 in accordance with one or more example embodiments. Specifically, the application interface 226 of the controller 204 receives data (e.g., information, communications, instructions, updates to firmware) from and sends data (e.g., information, communications, instructions) to the user system 255 of the user 250, the master controller 280, and/or the external systems 285. The user system 255 of the user 250, the master controller 280, and/or the external systems 285 can include an interface to receive data from and send data to the controller 204 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

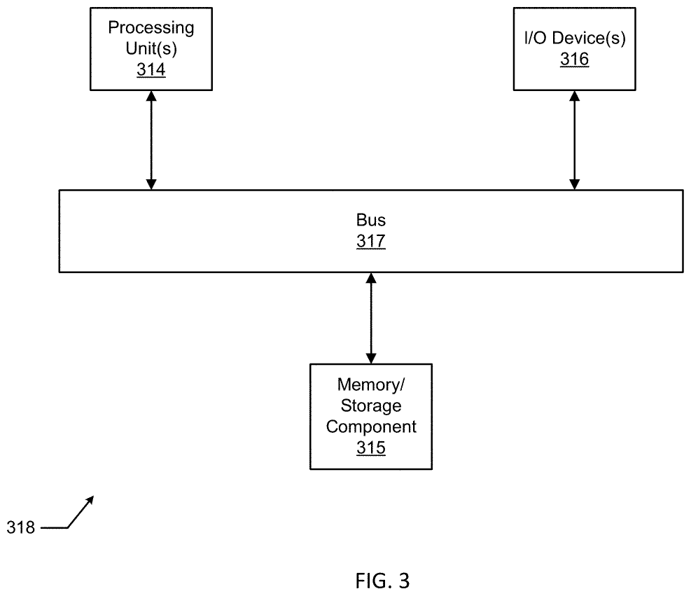

The controller 204, the user system 255 of the user 250, the master controller 280, and/or the external systems 285 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 204. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 3.

Further, as discussed above, such a system can have corresponding software (e.g., user software, photometric data tool software, network manager software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 200. The photometric data tool 202 can include an optional housing 203. In some cases, the housing 203 can be designed to comply with any applicable standards so that the photometric data tool 202 can be located in a particular environment (e.g., a humid environment, a cold environment).

The housing 203 of the photometric data tool 202 can be used to house one or more components of the photometric data tool 202, including one or more components of the controller 204. For example, as shown in FIG. 2, the controller 204 (which in this case includes the control engine 206, the communication module 208, the timer 210, the photometric data generator 235, the optional mapping module 211, the optional compliance module 237, the optional budgeting module 238, the optional inventory module 239, the power module 212, the storage repository 230, the hardware processor 220, the memory 222, the transceiver 224, the application interface 226, and the optional security module 228), the power supply 240, the optional sensors 260, and the interface 242 can be disposed in the formed by the housing 203 or integrated with the housing 203. In alternative embodiments, any one or more of these and/or other components of the photometric data tool 202 can be disposed on the housing 203 and/or remotely from the housing 203.

The storage repository 230 can be a persistent storage device (or set of devices) that stores software and data used to assist the controller 204 in communicating with the user system 255 of the user 250, the master controller 280, and the external systems 285 within the system 200. In one or more example embodiments, the storage repository 230 stores one or more protocols 232, algorithms 233, and stored data 234. The protocols 232 are any logic steps and/or methods followed by the control engine 206 or other components of the photometric data tool 202 based on certain conditions at a point in time. The protocols 232 can include any of a number of communication protocols that are used to send and/or receive data between the controller 204 and the user system 255 of the user 250, the master controller 280, and the external systems 285. A protocol 232 can also include any of a number of processes for requesting and receiving information from one or more external systems 285 in the system 200.

A protocol 232 can also be a method by which to implement one or more stages (e.g., calculating, forecasting, planning, scheduling, purchasing, implementing) performed by the photometric data tool 202 in association with designing of equipment and/or a system. In some cases, one or more of the protocols 232 can be used for communications. One or more of the protocols 232 can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the protocols 232 can provide a layer of security to the data transferred within the system 200.

As an example, one or more protocols 232 can be used to direct the control engine 206 of the controller 204 to “look up” or retrieve certain data (e.g., stored in the storage repository 230 as stored data 234, held by one or more external systems 285) that can be used to generate photometric data for a customized light fixture. Such data can be actual measured photometric data (e.g., measured in a lab) associated with, for example, light fixtures having at least one feature (e.g., manufacturer, type of light fixture, style of light fixture, power requirements, size of light fixture, type of light source, light distribution) in common with the customized light fixture and/or previously calculated photometric data for light fixtures having at least one feature in common with the customized light fixture. A protocol 232 can also be used to determine which particular data (e.g., lumens, watts, current) is used in generating photometric data for a customized light fixture.

The algorithms 233 can be any formulas, mathematical models, and/or other similar operational tools that the control engine 206 of the controller 204 uses. An example of an algorithm 233 is designing a standard or customized light fixture for use in a volume of space in light of existing equipment and systems, lighting needs and requirements, code and regulatory requirements, cost, and/or any of a number of other factors. An algorithm 233 can be fixed or modified (e.g., by a user 250 on the user system 255, by the control engine 206) over time. Modification of an algorithm 233 can be based on one or more of a number of factors, including but not limited to a new external system 285 (or information provided thereby), an instruction from a user 250 on the user system 255, and correction based on actual data.

As a specific example, an algorithm 233 can be used to estimate lighting characteristics of a customized light fixture based on certain inputs (e.g., length, width, type of light source, type of light fixture, type of lens) provided by a user 250 (e.g., on a user system 250, using the interface 242 of the photometric data tool 202). In such a case, the algorithm 233 can provide estimates for a number of default characteristics and/or for characteristics requested by the user 250. The algorithm 233 in this example can use stored data 234 (e.g., actual test results for light fixtures having at least one common characteristic with the customized light fixture, actual test results for the same type of light fixture of differing sizes).

Stored data 234 can be or include historical test results of any of a number of light fixtures, any data (e.g., processing speed) associated with the photometric data tool 202 (including other photometric data tools 202 and/or any components thereof), any data associated with an external system 285, any measurements taken by the optional sensors 260, outputs of the optional mapping module 211, threshold values, results of previously run or calculated algorithms 233, and/or any other suitable data. Such data can be any type of data, including but not limited to historical data (e.g., results of previously-run algorithms 233, prior calculations, prior results from the optional budgeting module 238), current data (e.g., measurements taken by one or more optional sensors 260, inputs provided by a user 250 for a present inquiry), and forecasts. The stored data 234 can be associated with some measurement of time derived, for example, from the timer 210.

Examples of a storage repository 230 can include, but are not limited to, a database (or a number of databases), a file system, a hard drive, flash memory, some other form of solid state data storage, or any suitable combination thereof. The storage repository 230 can be located on multiple physical machines, each storing all or a portion of the protocols 232, the algorithms 233, and/or the stored data 234 according to some example embodiments. Each storage unit or device can be physically located in the same or in a different geographic location.

The storage repository 230 can be operatively connected to the control engine 206. In one or more example embodiments, the control engine 206 includes functionality to communicate with the user system 255 of the user 250, the master controller 280, and the external systems 285 in the system 200. More specifically, the control engine 206 sends information to and/or receives information from the storage repository 230 in order to communicate with the user system 255 of the user 250, the master controller 280, and the external systems 285. As discussed below, the storage repository 230 can also be operatively connected to the communication module 208 in certain example embodiments.

In certain example embodiments, the control engine 206 of the controller 204 controls the operation of one or more components (e.g., the communication module 208, the timer 210, the transceiver 224, the photometric data generator 235, the optional mapping module 211, the optional compliance module 237, the optional budgeting module 238, the optional inventory module 239) of the controller 204. For example, the control engine 206 can activate the communication module 208 when the communication module 208 is in “sleep” mode and when the communication module 208 is needed to send data received from another component (e.g., an external system 285, the user system 255 of the user 250) in the system 200.

As another example, the control engine 206 can acquire the current time using the timer 210. The timer 210 can enable the controller 204 to control the photometric data tool 202 even when the controller 204 has no communication with the master controller 280. As yet another example, the control engine 206 can direct the optional mapping module 211 to run a scenario and subsequently send the results to the master controller 280. In some cases, the control engine 206 of the controller 204 can generate and send a signal to the power supply 240, which causes the interface 242 and/or one or more of the sensors 260 to operate.

The control engine 206 can be configured to perform a number of functions that help the photometric data tool 202 (or components thereof) perform one or more functions (e.g., planning, purchasing, budgeting, scheduling, implementing) of an estimation process for existing and/or customized light fixtures. As discussed above, the control engine 206 can execute any of the protocols 232 and/or the algorithms 233, using stored data 234 stored in the storage repository 230 and/or information provided by one or more external systems 285, to perform one or more functions of an estimation process.

As an example, the control engine 206 of the controller 204 can use one or more protocols 232 to “look up” certain historical photometric data (e.g., stored in the storage repository 230 as stored data 234, held by one or more external systems 285) that can be used to generate photometric data for a customized light fixture. Such data can be associated with, for example, similar light fixtures (e.g., light fixtures from the same manufacturer, light fixtures with the same type of light source, light fixtures of the same type (e.g., troffer, down can, linear), light fixtures of similar shape/size) that have actual measured photometric data (e.g., measured in a lab) and/or previously calculated photometric data for the same or similar light fixtures. The control engine 206 can also use one or more protocols 232 to determine which particular data (e.g., lumens, watts, current) is used in generating photometric data for a customized light fixture.

For example, the control engine 206 can use one or more algorithms 233 and one or more protocols 232 to estimate lighting characteristics (photometric data) of a customized light fixture based on certain inputs (e.g., length, width, type of light source, type of customized light fixture, manufacturer of the customized light fixture, type of lens) provided by a user 250 (e.g., on a user system 250, using the interface 242 of the photometric data tool 202) and/or an external system 285. In such a case, the control engine 206, using the algorithms 233, can generate estimates of photometric data for a number of default characteristics and/or for characteristics requested by the user 250. These estimates can be derived by the control engine 206 using stored data 234 (e.g., actual test results for light fixtures having at least one common characteristic with the customized light fixture, actual test results for the same type of light fixture of differing sizes) and inputs from a user 250. In some cases, the control engine 206 can generate and/or retrieve photometric data for light fixtures that are not customized.

The control engine 206 can provide control, communication, and/or other similar signals to the user system 255 of the user 250, the master controller 280, and the external systems 285. Similarly, the control engine 206 can receive control, communication, and/or other similar signals from the user system 255 of the user 250, the master controller 280, and the external systems 285. The control engine 206 can control each sensor 260 automatically (for example, based on one or more protocols 232 or algorithms 233 stored in the control engine 206) and/or based on control, communication, and/or other similar signals received from another component of the system 200 through a communication link 205. The control engine 206 may include a printed circuit board, upon which the hardware processor 220 and/or one or more discrete components of the controller 204 are positioned.

As stated above, in certain embodiments, the control engine 206 of the controller 204 can communicate with one or more external systems 285 in furtherance of providing estimations for a system and/or equipment (e.g., a customized light fixture) within a volume of space. For example, the control engine 206 can interact with an inventory management system (an external system 285) to determine what equipment is currently in inventory and at what location. As another example, the control engine 206 can interact with a workforce scheduling system (another external system 285) by scheduling a construction crew (e.g., electricians, mechanics, instrument and control technicians) to install or replace a customized light fixture in a volume of space. In this way, the controller 204 is capable of performing a number of functions beyond what could reasonably be considered a routine task.

In certain example embodiments, the control engine 206 can include a communication interface that enables the control engine 206 to communicate with one or more components (e.g., power supply 240) of the photometric data tool 202. For example, if the power supply 240 of the photometric data tool 202 operates under IEC Standard 62386, then the power supply 240 can have a serial communication interface that will transfer data (e.g., stored data 234) from an external system 285. In such a case, the control engine 206 can also include a serial interface to enable communication with the power supply 240 within the photometric data tool 202. Such an interface can operate in conjunction with, or independently of, the protocols 232 used to communicate between the controller 204 and the user system 255 of the user 250, the master controller 280, and the external systems 285.

The control engine 206 (or other components of the controller 204) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I²C), and a pulse width modulator (PWM).

The communication module 208 of the controller 204 determines and implements the communication protocol (e.g., from the protocols 232 of the storage repository 230) that is used when the control engine 206 communicates with (e.g., sends signals to, receives signals from) the user system 255 of the user 250, the master controller 280, and/or the external systems 285. In some cases, the communication module 208 accesses the stored data 234 to determine which protocol 232 is used to communicate with an external system 285 associated with the stored data 234. In addition, the communication module 208 can interpret the protocol 232 of a communication received by the controller 204 so that the control engine 206 can interpret the communication.

The communication module 208 can send and receive data between the master controller 280, the optional sensors 260, the optional external systems 285, the user system 255 of the user 250, and the controller 204. The communication module 208 can send and/or receive data in a given format that follows a particular protocol 232. The control engine 206 can interpret the data packet received from the communication module 208 using the protocol 232 information stored in the storage repository 230. The control engine 206 can also facilitate the data transfer between one or more sensors 260 and the master controller 280, the external systems 285, and/or a user system 255 of a user 250 by converting the data into a format understood by the communication module 208.

The communication module 208 can send data (e.g., protocols 232, algorithms 233, stored data 234, operational information, model results) directly to and/or retrieve data directly from the storage repository 230. Alternatively, the control engine 206 can facilitate the transfer of data between the communication module 208 and the storage repository 230. The communication module 208 can also provide encryption to data that is sent by the controller 204 and decryption to data that is received by the controller 204. The communication module 208 can also provide one or more of a number of other services with respect to data sent from and received by the controller 204. Such services can include, but are not limited to, data packet routing information and procedures to follow in the event of data interruption.

The timer 210 of the controller 204 can track clock time, intervals of time, an amount of time, and/or any other measure of time. The timer 210 can also count the number of occurrences of an event, whether with or without respect to time. Alternatively, the control engine 206 can perform the counting function. The timer 210 is able to track multiple time measurements concurrently. The timer 210 can track time periods based on an instruction received from the control engine 206, based on an instruction received from the user system 255 of the user 250, based on an instruction programmed in the software for the controller 204, based on some other condition or from some other component, or from any combination thereof.

The timer 210 can be configured to track time when there is no power delivered to the controller 204 (e.g., the power module 212 malfunctions) using, for example, a super capacitor or a battery backup. In such a case, when there is a resumption of power delivery to the controller 204, the timer 210 can communicate any aspect of time to the controller 204. In such a case, the timer 210 can include one or more of a number of components (e.g., a super capacitor, an integrated circuit) to perform these functions.

The photometric data generator 235 of the controller 204 is configured to generate customized photometric data (also more simply called photometric data herein) for a light fixture (e.g., a standard light fixture, a customized light fixture). To generate the customized photometric data, the photometric data generator 235 can use one or more algorithms 233 and/or protocols 232, as well as photometric data (e.g., an .ies file received from an external system 285, a type of stored data 234 in the storage repository 230) for the same or similar light fixtures (i.e., light fixtures having at least one characteristics that is in common with the customized light fixture) that have already been tested and/or modeled previously by the photometric data generator 235.

For example, a user 250 can be interested in the light output characteristics (e.g., lumens, efficacy) of a light fixture having a customized length and/or width, as selected by the user 250 (for example, in the mapping module 211, or as input by a user 250 through the interface 242). In such a case, the photometric data generator 235 can use the inputs provided by the user 250, along with historical test data (stored data 234) and/or results of previously-run algorithms 233, to generate estimates of the photometric data for the selected light fixture. Similarly, if the user 250 adjusts one or more of the inputs, then the photometric data generator 235 can generate revised estimates of the photometric data for the selected light fixture.

The inputs provided by the user 250 to the photometric data generator 235 can be default inputs and/or inputs that are selected by the user 250. Similarly, the specific photometric data for a selected light fixture that is generated by the photometric data generator 235 can be according to default parameters and/or user preferences or selections. The customized photometric data generated by the photometric data generator 235 can be presented in one or more of any of a number of formats. For example, the photometric data generator 235 can generate a file (e.g., with an .ies extension) that includes the photometric data for the customized light fixture.

The optional mapping module 211 of the controller 204 is capable of mapping existing and/or potential systems (including components (e.g., equipment, light fixtures) thereof) in a volume of space. For example, the various elements shown in the volume of space 199 of FIG. 1 can be an output of the mapping module 211. The mapping module 211 can work at the direction of the control engine 206 to function. The mapping module 211 can receive information about the existing and potential systems from one or more of any number of sources. For example, the mapping module 211 can receive the dimensions of a room from an architectural engineering database (a type of external system 285) and/or from measurements taken by one or more sensors 260. As another example, the mapping module 211 can receive the location of conduit, outlets, switches, and wiring for a room from an electrical engineering database (another type of external system 285).

As yet another example, the mapping module 211 can receive the proposed layout and equipment for a lighting system from the control engine 206 via a user system 255 of the user 250, through the interface 242, or via some other form of communication. As still another example, some or all of the output of one or more other modules (e.g., the inventory module 239) can be available to the mapping module 211. If a conflict exists between a proposed layout of equipment and existing equipment, the mapping module 211 can notify the control engine 206 of the conflict. In some cases, the mapping module 211 can suggest one or more alternatives for resolving such a conflict. The mapping module 211 can initiate contact, through the control engine 206, with one or more external systems 285, the user system 255 of the user 250, and/or the master controller 280 to retrieve initial information, or if additional information is needed to generate an output of the mapping module 211.

The optional inventory module 239 can determine any information associated with the various equipment being estimated and/or selected for installation of a proposed customized light fixture. Such information can include, but is not limited to, whether the equipment is available (e.g., can be manufactured, is in inventory), where such equipment is held in inventory, any applicable vendor information, and the expected delivery time. The inventory module 239 can work at the direction of the control engine 206 to function. The inventory module 239 can receive information about the proposed installation from one or more of any number of sources.

For example, some or all of the output of one or more other modules (e.g., the mapping module 211) can be available to the inventory module 239. As another example, the inventory module 239 can receive the inventory, manufacturer, and/or vendor information from an inventory management system (a type of external system 285). As yet another example, the inventory module 239 can receive the delivery information from a shipping vendor system (another type of external system 285). If there are multiple options for a certain piece of equipment, the inventory module 239 can present these multiple options along with any associated information (e.g., quality, price, estimated delivery date).

If there are multiple manufacturers and/or distributors that can provide a particular customized light fixture, the inventory module 239 can generate a request for proposal from those parties. In addition, the inventory module 239 can receive and/or evaluate bids from those parties in response to the request for proposal. In evaluating these multiple bids, the inventory module 239 can request additional information and/or clarification to be able to thoroughly evaluate those bids.

The information about the proposed equipment that is searched by the inventory module 239 can be received from the control engine 206 via the user system 255 of the user 250 through the interface 242 or some other form of communication. The inventory module 239 can initiate contact, through the control engine 206, with one or more external systems 285, the user system 255 of the user 250, and/or the master controller 280 to retrieve initial information, or if additional information is needed to generate an output of the inventory module 239.

The optional compliance module 237 can determine whether a proposed installation of a customized light fixture would be in compliance with any applicable codes or regulations. The compliance module 237 can work at the direction of the control engine 206 to function. The compliance module 237 can receive information about the potential systems from one or more of any number of sources. For example, some or all of the output of one or more other modules (e.g., the photometric data generator 235, the mapping module 211) can be available to the compliance module 237. As another example, the compliance module 237 can obtain any applicable codes and/or regulations for a proposed installation of a customized light fixture from government regulatory database and/or an industry standards database (types of external systems 285).

If there is a violation of a code or regulation for a proposed installation (including a proposed customized light fixture), the compliance module 237 can identify the violation and, in some cases, working in conjunction with the photometric data generator 235, propose solutions (either specific or generalized) for overcoming the violation. In such a case, the compliance module 237 can provide one or more inputs to the photometric data generator 235 to generate results that put the proposed light fixture (as well as the associated system) in compliance with applicable codes and/or regulations.

The proposed installation of a customized light fixture that is searched by the compliance module 237 can be received from the control engine 206 via the user system 255 of the user 250 through the interface 242 or some other form of communication. The compliance module 237 can initiate contact, through the control engine 206, with one or more external systems 285, the user system 255 of the user 250, and/or the master controller 280 to retrieve initial information, or if additional information is needed to generate an output of the compliance module 237.

The optional budgeting module 238 can determine a cost estimate (e.g., equipment cost, installation cost, projected maintenance costs) of a proposed installation, including a customized light fixture. The budgeting module 238 can also project costs associated with operating a proposed installation, including a customized light fixture. The budgeting module 238 can also compare various costs of one or more proposed installations of a customized light fixture and, in some cases, with an existing system if the proposed installation would replace the existing system.

The budgeting module 238 can work at the direction of the control engine 206 to function. The budgeting module 238 can receive information about a proposed customized light fixture and its installation from one or more of any number of sources. For example, some or all of the output of one or more other modules (e.g., the photometric data generator 235, the mapping module 211) can be available to the budgeting module 238. As another example, the budgeting module 238 can obtain any pricing information for a proposed customized light fixture and its installation from a manufacturer, a vendor sales database, and/or other similar source (a type of external system 285). As yet another example, the budgeting module 238 can obtain any product performance information for a proposed customized light fixture and its installation from a product performance database or a vendor system (other types of external systems 285).

If there is an issue with a budget (e.g., expected costs of an installation exceed a budgeted amount) for a proposed customized light fixture and its installation, the budgeting module 238 can identify the issue and, in some cases, propose solutions (either specific or generalized) for overcoming the violation (e.g., suggest alternative equipment). In such a case, the budgeting module 238 can provide one or more inputs to the photometric data generator 235 to generate results that put the proposed light fixture (as well as the associated system) in compliance with a budgetary requirement.

The proposed customized light fixture and its installation that is researched by the budgeting module 238 can be received from the control engine 206 via the user system 255 of the user 250 through the interface 242 or some other form of communication. The budgeting module 238 can initiate contact, through the control engine 206, with one or more external systems 285, the user system 255 of the user 250, and/or the master controller 280 to retrieve initial information, or if additional information is needed to generate an output of the budgeting module 238.

In some cases, one or more additional modules can be included in a controller 204 of an example photometric data tool 202. Alternatively, the control engine 206 can perform additional functions in lieu of adding a module. For example, if a lighting system having one or more customized light fixtures is considered for a certain aesthetic appeal, an appropriate module can be added to the controller 204 to analyze the aesthetic appeal of the proposed customized light fixture and its installation, working in conjunction with the photometric data generator 235 and/or the other modules of the controller 204. Alternatively, rather than adding such a module in this example, the capabilities of the control engine 206 can be expanded to perform these functions.

The power module 212 of the controller 204 provides power to one or more other components (e.g., timer 210, control engine 206) of the controller 204. In addition, in certain example embodiments, the power module 212 can provide power to the power supply 240 of the photometric data tool 202. The power module 212 can include one or more of a number of single or multiple discrete components (e.g., transistor, diode, resistor), and/or a microprocessor. The power module 212 may include a printed circuit board, upon which the microprocessor and/or one or more discrete components are positioned. In some cases, the power module 212 can include one or more components that allow the power module 212 to measure one or more elements of power (e.g., voltage, current) that is delivered to and/or sent from the power module 212.

The power module 212 can receive power (for example, through an electrical cable) from a source (e.g., the power supply 240) external to the controller 204 and generates power of a type (e.g., alternating current, direct current) and level (e.g., 12V, 24V, 120V) that can be used by the other components of the controller 204. The power module 212 can use a closed control loop to maintain a preconfigured voltage or current with a tight tolerance at the output. The power module 212 can also protect the rest of the electronics (e.g., hardware processor 220, transceiver 224) in the photometric data tool 202 from surges generated in the line.

In addition, or in the alternative, the power module 212 can be a source of power in itself to provide signals to the other components of the controller 204. For example, the power module 212 can be or include a battery, a supercapacitor, and/or other form of energy storage device. As another example, the power module 212 can be or include a localized photovoltaic power system. In certain example embodiments, the power module 212 of the controller 204 can also provide power and/or control signals, directly or indirectly, to one or more of the optional sensors 260. In such a case, the control engine 206 can direct the power generated by the power module 212 to the sensors 260 and/or the interface 242 of the photometric data tool 202. In this way, power can be conserved by sending power to the sensors 260 and/or the interface 242 of the photometric data tool 202 when those devices need power, as determined by the control engine 206.

The hardware processor 220 of the controller 204 executes software, algorithms 233, and firmware in accordance with one or more example embodiments. Specifically, the hardware processor 220 can execute software on the control engine 206 or any other portion of the controller 204, as well as software used by the user system 255 of the user 250, the master controller 280, the external systems 285, and/or one or more of the optional sensors 260. The hardware processor 220 can be an integrated circuit, a central processing unit, a multi-core processing chip, SoC, a multi-chip module including multiple multi-core processing chips, or other hardware processor in one or more example embodiments. The hardware processor 220 is known by other names, including but not limited to a computer processor, a microprocessor, and a multi-core processor.

In one or more example embodiments, the hardware processor 220 executes software instructions stored in memory 222. The memory 222 includes one or more cache memories, main memory, and/or any other suitable type of memory. The memory 222 can include volatile and/or non-volatile memory. The memory 222 is discretely located within the controller 204 relative to the hardware processor 220 according to some example embodiments. In certain configurations, the memory 222 can be integrated with the hardware processor 220.

In certain example embodiments, the controller 204 does not include a hardware processor 220. In such a case, the controller 204 can include, as an example, one or more field programmable gate arrays (FPGA), insulated-gate bipolar transistors (IGBTs), and integrated circuits (ICs). Using FPGAs, IGBTs, ICs, and/or other similar devices known in the art allows the controller 204 (or portions thereof) to be programmable and function according to certain logic rules and thresholds without the use of a hardware processor. Alternatively, FPGAs, IGBTs, ICs, and/or similar devices can be used in conjunction with one or more hardware processors 220.

The transceiver 224 of the controller 204 can send and/or receive control and/or communication signals. Specifically, the transceiver 224 can be used to transfer data between the controller 204 and the user system 255 of the user 250, the master controller 280, the external systems 285, and/or the optional sensors 260 (e.g., if remote from the photometric data tool 202). The transceiver 224 can use wired and/or wireless technology. The transceiver 224 can be configured in such a way that the control and/or communication signals sent and/or received by the transceiver 224 can be received and/or sent by another transceiver that is part of the user system 255 of the user 250, the master controller 280, one or more of the external systems 285, and/or the sensors 260. The transceiver 224 can use any of a number of signal types, including but not limited to radio frequency signals.

When the transceiver 224 uses wireless technology, any type of wireless technology can be used by the transceiver 224 in sending and receiving signals. Such wireless technology can include, but is not limited to, Wi-Fi, visible light communication (VLC), cellular networking, UART, SPI, I2C, 802.15.4 wireless, ZigBee, 4G cellular wireless, and Bluetooth. The transceiver 224 can use one or more of any number of suitable communication protocols (e.g., ISA100, HART) when sending and/or receiving signals. Such communication protocols can be stored in the protocols 232 of the storage repository 230. Further, any transceiver information for the user system 255 of the user 250, the master controller 280, the external systems 285, and/or the sensors 260 can be part of the stored data 234 (or similar areas) of the storage repository 230.

Optionally, in one or more example embodiments, the security module 228 secures interactions between the controller 204, the user system 255 of the user 250, the master controller 280, the external systems 285, and/or the sensors 260. More specifically, the security module 228 authenticates communication from software based on security keys verifying the identity of the source of the communication. For example, user software may be associated with a security key enabling the software of the user system 255 of the user 250 to interact with the controller 204 and/or the external systems 285. Further, the security module 228 can restrict receipt of information, requests for information, and/or access to information in some example embodiments.

As stated above, the photometric data tool 202 can be used in any of a number of environments. In such a case, the housing 203 of the photometric data tool 202 can be configured to comply with applicable standards for any of a number of environments. For example, the photometric data tool 202 can be rated as a Division 1 or a Division 2 enclosure under NEC standards. Similarly, any of the sensors 260, the interface 242, and/or other devices or components communicably coupled to the photometric data tool 202 can be configured to comply with applicable standards for any of a number of environments. For example, a sensor 260 can be rated as a Division 1 or a Division 2 enclosure under NEC standards.

FIG. 3 illustrates one embodiment of a computing device 318 that implements one or more of the various techniques described herein, and which is representative, in whole or in part, of the elements described herein pursuant to certain exemplary embodiments. Computing device 318 is one example of a computing device and is not intended to suggest any limitation as to scope of use or functionality of the computing device and/or its possible architectures. Neither should computing device 318 be interpreted as having any dependency or requirement relating to any one or combination of components illustrated in the example computing device 318.

Computing device 318 includes one or more processors or processing units 314, one or more memory/storage components 315, one or more input/output (I/O) devices 316, and a bus 317 that allows the various components and devices to communicate with one another. Bus 317 represents one or more of any of several types of bus structures, including a memory bus or memory controller, a peripheral bus, an accelerated graphics port, and a processor or local bus using any of a variety of bus architectures. Bus 317 includes wired and/or wireless buses.

Memory/storage component 315 represents one or more computer storage media. Memory/storage component 315 includes volatile media (such as random access memory (RAM)) and/or nonvolatile media (such as read only memory (ROM), flash memory, optical disks, magnetic disks, and so forth). Memory/storage component 315 includes fixed media (e.g., RAM, ROM, a fixed hard drive, etc.) as well as removable media (e.g., a Flash memory drive, a removable hard drive, an optical disk, and so forth).

One or more I/O devices 316 allow a customer, utility, or other user to enter commands and information to computing device 318, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 318 is connected to a network (not shown) (e.g., a LAN, WAN such as the Internet, cloud, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 318 includes at least the minimal processing, input, and/or output means necessary to practice one or more embodiments.

Further, those skilled in the art will appreciate that one or more elements of the aforementioned computer device 318 is located at a remote location and connected to the other elements over a network in certain exemplary embodiments. Further, one or more embodiments is implemented on a distributed system having one or more nodes, where each portion of the implementation (e.g., control engine 206) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

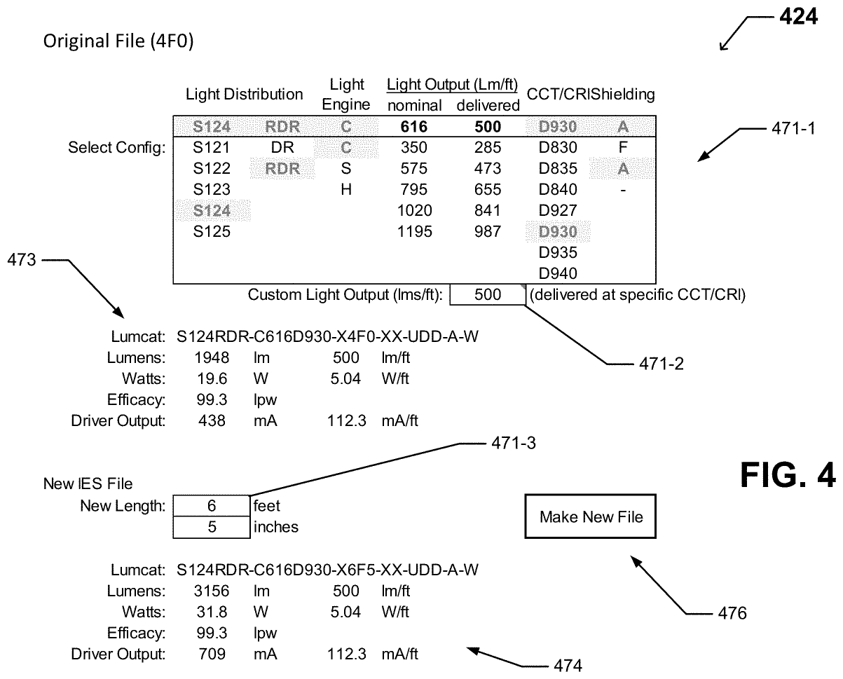

FIG. 4 shows an interface 424 used to generate photometric data 474 in accordance with certain example embodiments. Referring to FIGS. 1-4, as discussed above, the interface 442 can be physical or virtual and have any of a number of features. In this example, the interface 442 includes an interactive display that solicits a number of inputs 471 from, for example, a user, for a customized light fixture. Specifically, the interface 442 of FIG. 4 includes an interactive table 471-1 that allows for the selection of configuration variables of the customized light fixture such as light distribution, the light engine, light output (nominal and delivered), CCT/CRI, and shielding. In this case, the selections in the interactive table 471-1 are a light distribution of S124 with a regressed lens (RDR), a light engine of C, a nominal light output of 616 lumens per foot, a CCT/CRI of 3000k/90CRI, and shielding of A.

The interface 442 also has an input field 471-2 (in this case, free form, but can take other forms including but not limited to drop down menu, selection by radio button or checkbox) for a delivered light output of the customized light fixture. In this case, the delivered light output is selected as 500 lumens per foot. The interface 442 further has an input field 471-3 (in this case, free form, but can take other forms including but not limited to drop down menu, selection by radio button or checkbox) for a length of the customized light fixture. In this case, the length of the customized light fixture is selected as 6 feet and 5 inches.

The interface 442 can also show some of the characteristics 473 of the light fixture that is deemed most comparable to the customized light fixture based on the inputs 471, and so the previously-measured photometric data of that light fixture is used by the photometric data generator 235 to generate the photometric data of the customized light fixture. The characteristics of the customized light fixture 473 in this case include the manufacturer and model number of the light fixture (in this case, S124RDR-C616D930-X4F0-XX-UDD-A-W), the light output (in this case, 1948 lumens), the power requirements (in this case, 19.6 watts), the efficacy (in this case, 99.3 lpw), and the driver output (in this case, 438 milliamps).

The interface 442 can further include one or more outputs 474. In this case, the outputs 474 are characteristics of the customized light fixture. Specifically, the outputs in this example include the manufacturer and model number (to the extent known) of the customized light fixture, the light output (in lumens) of the customized light fixture, the power requirements (in watts) of the customized light fixture, the efficacy of the customized light fixture, and the driver output (in milliamps) of the customized light fixture. The interface 442 of FIG. 4 also includes a pushbutton 476 to make a new file for a customized light fixture having at least one different input relative to the customized light fixture generated in FIG. 4.

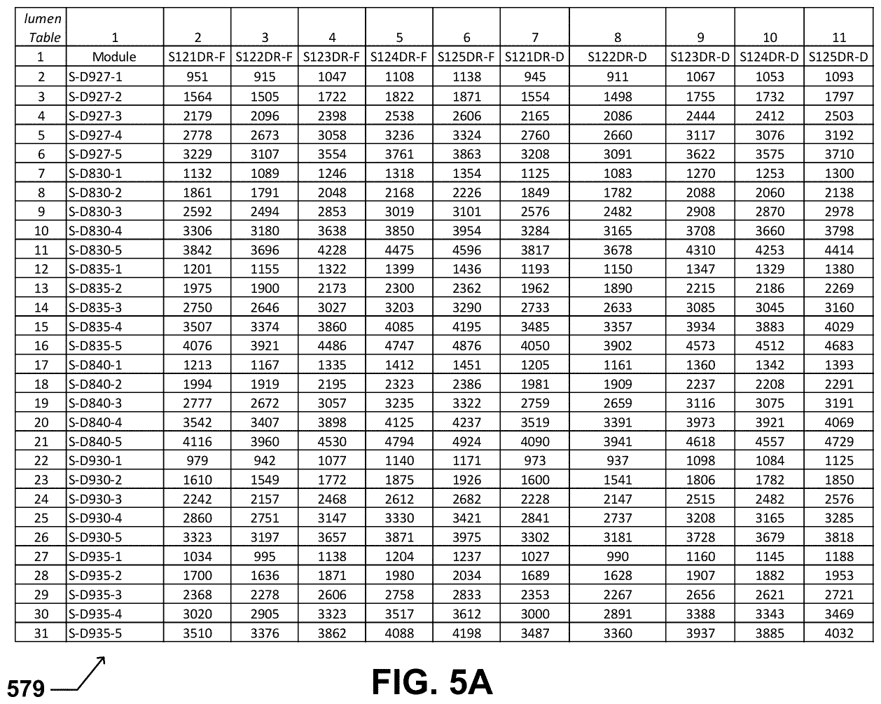

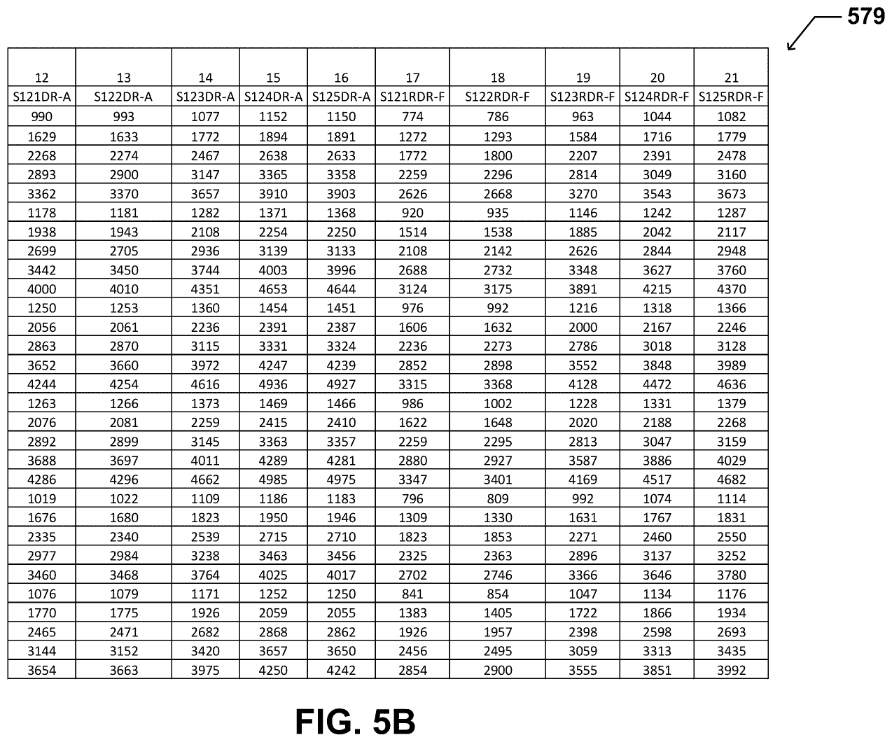

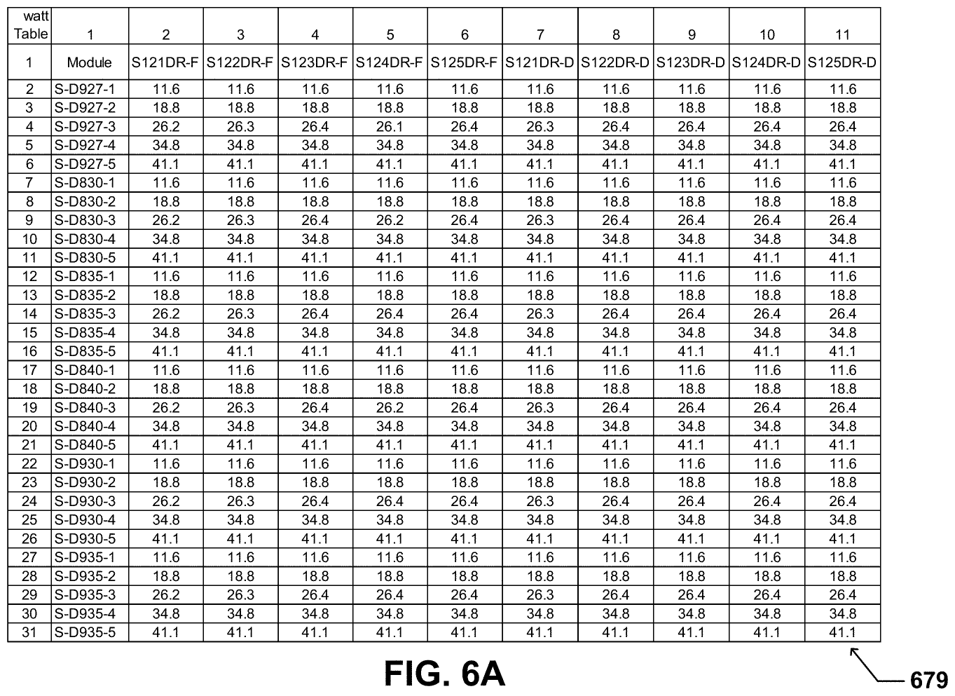

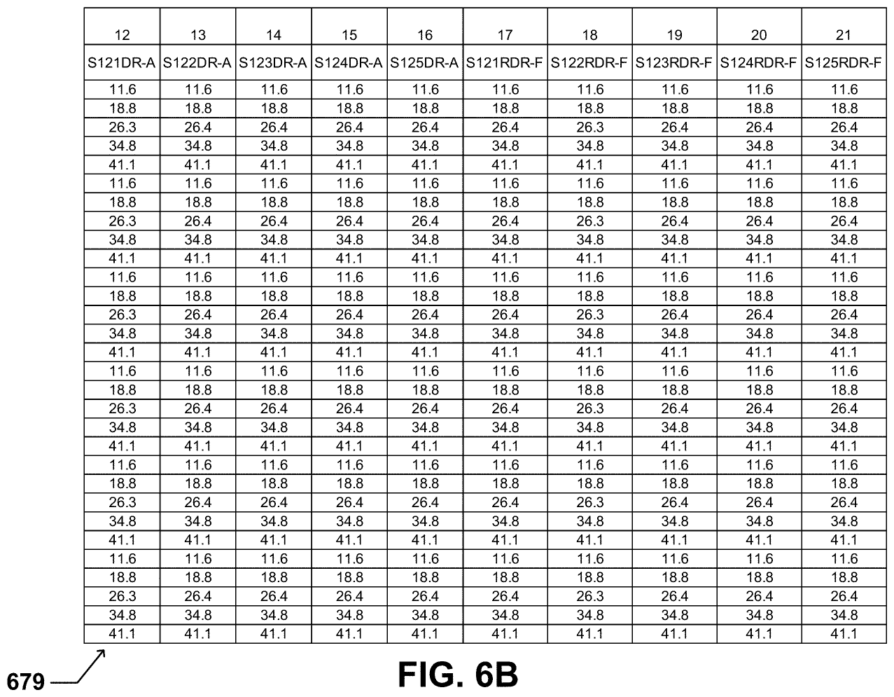

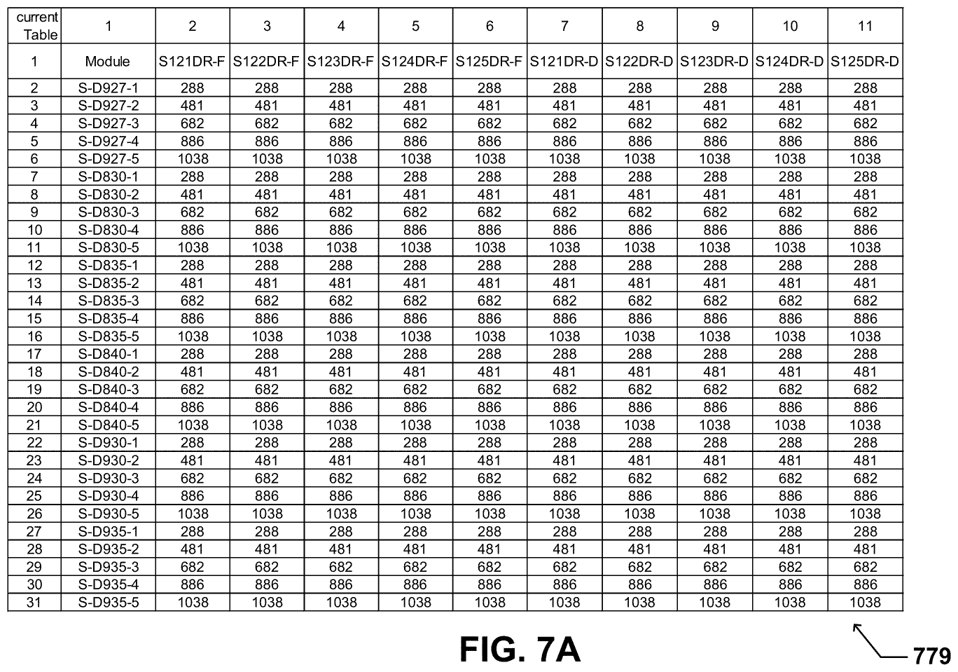

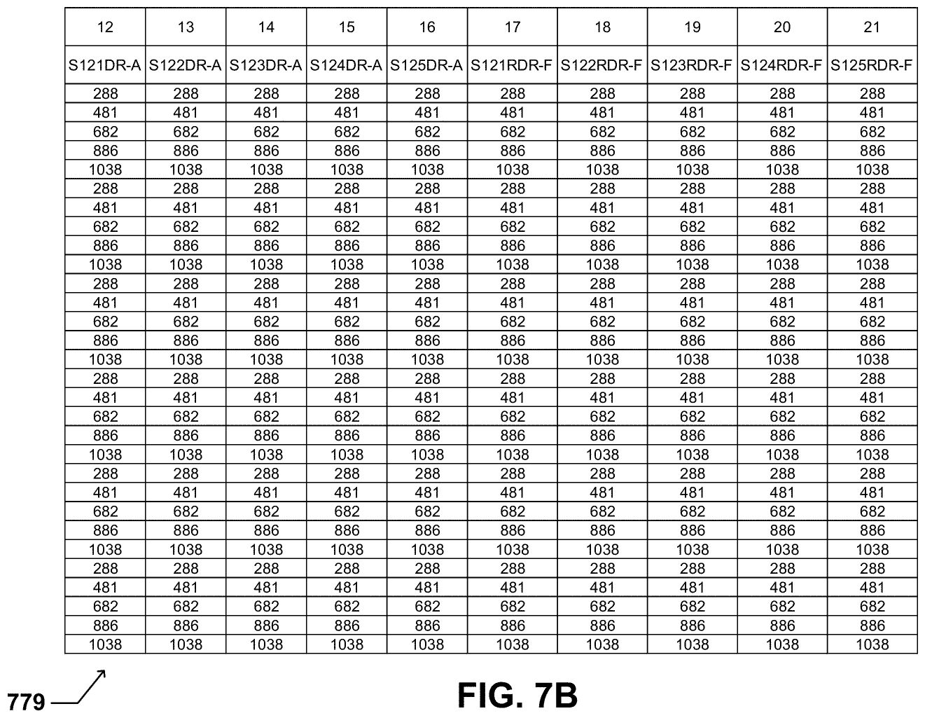

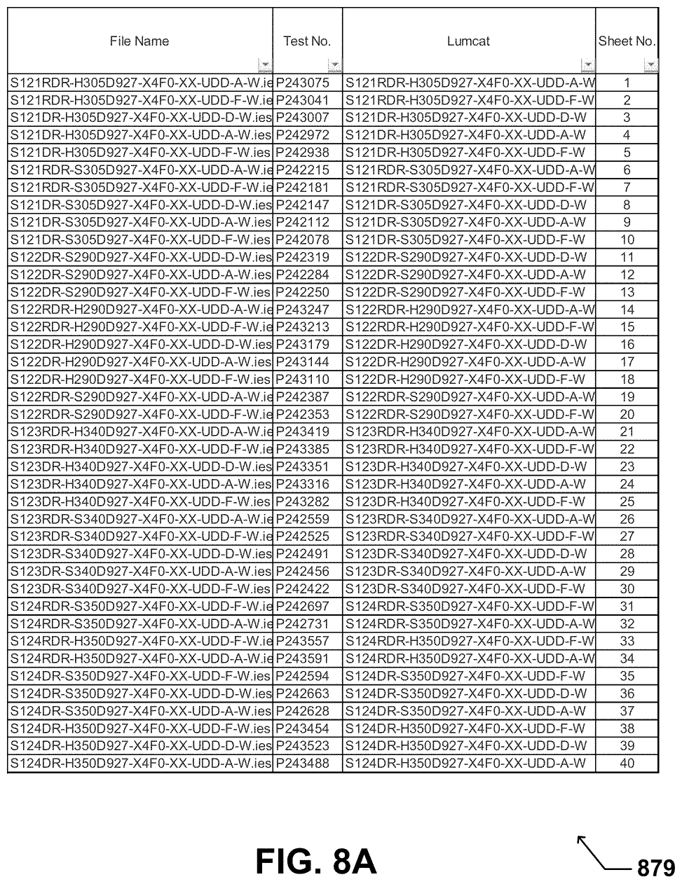

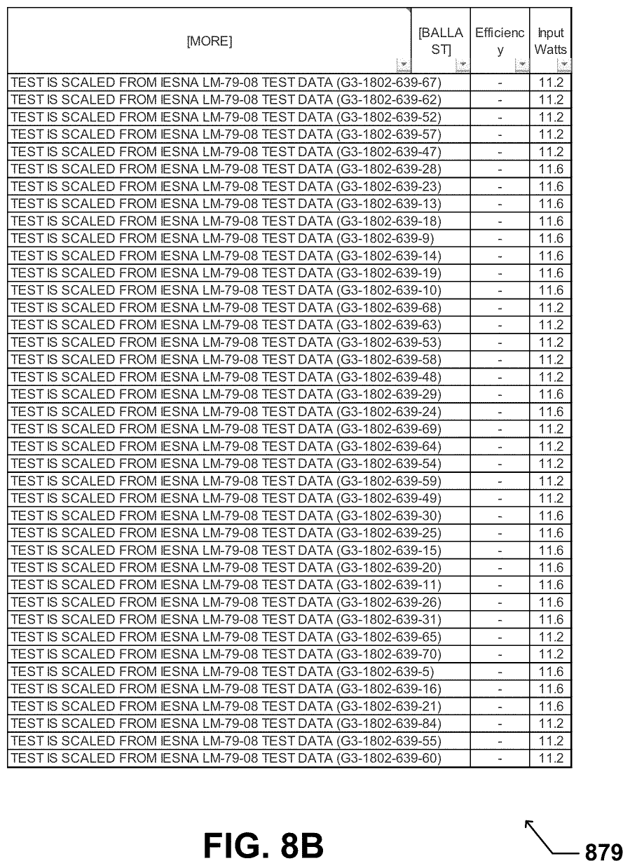

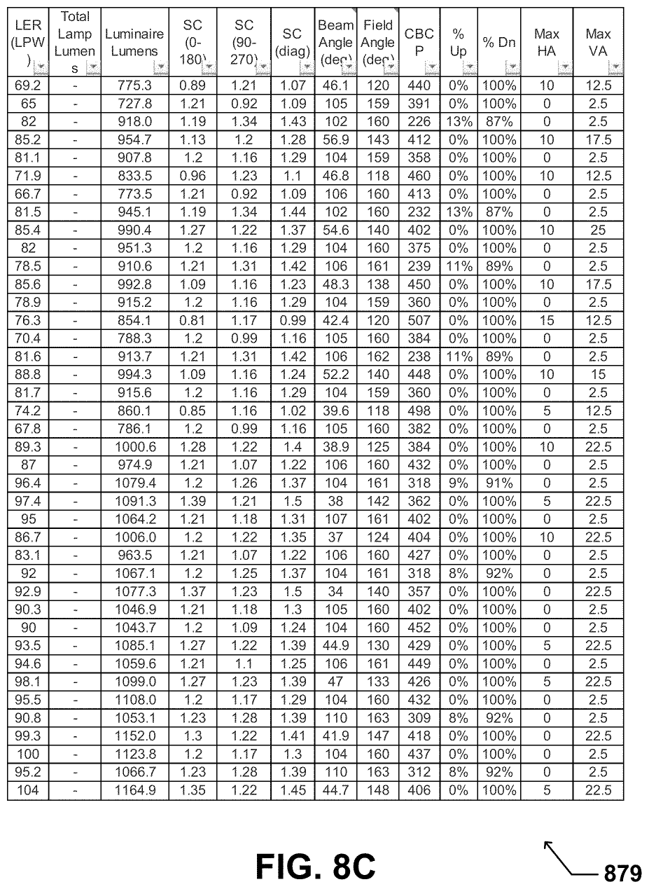

FIGS. 5A through 8C show various tables of historical photometric data in accordance with certain example embodiments. Specifically, referring to FIGS. 1 through 8C, FIGS. 5A and 5B show part of a table 579 of previously-measured light fixtures in terms of lumens. FIGS. 6A and 6B show shows part of a table 679 of previously-measured light fixtures in terms of watts. FIGS. 7A and 7B show shows part of a table 779 of previously-measured light fixtures in terms of LED drive current. FIGS. 8A through 8C show shows part of a table 879 of a number of base files of previously-measured light fixtures. The tables of FIGS. 5A through 8C are examples of tables that the control engine 206 (or, more specifically, the photometric data generator 235) uses to generate photometric data for a customized light fixture.

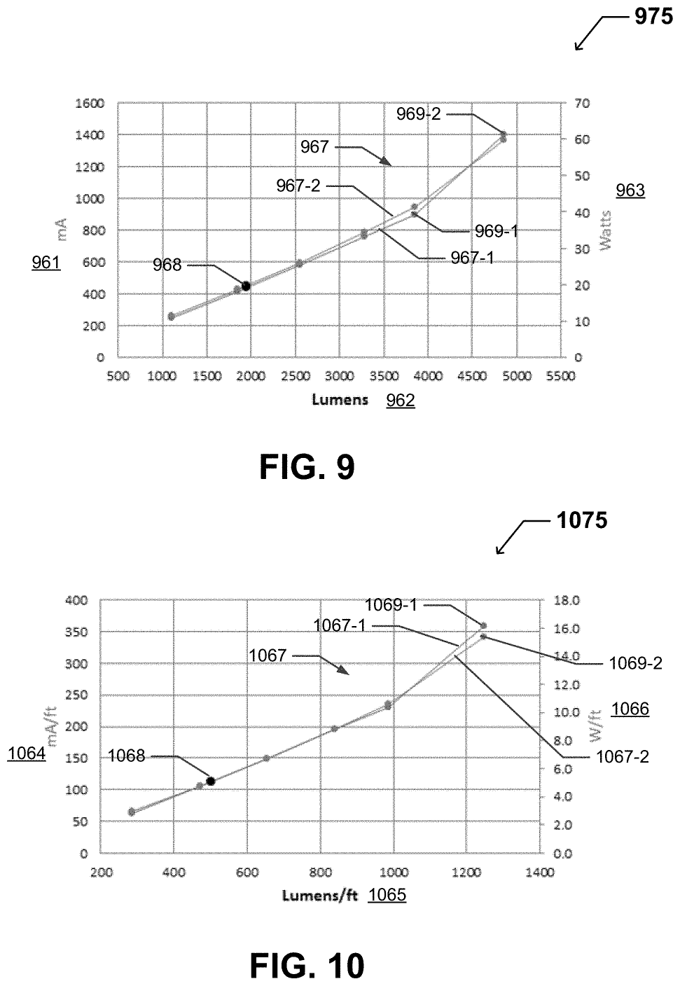

FIGS. 9 and 10 show graphs of photometric data in accordance with certain example embodiments. Specifically, referring to FIGS. 1-10, FIG. 9 shows a graph 975 with two plots 967 (plot 967-1 and plot 967-2). Plot 967-1 is based on multiple data points 969-1 (measured photometric data) of current 961 (in milliamps) versus lumens 962. Plot 967-2 is based on multiple data points 969-2 (measured photometric data) of power 963 (in watts) versus lumens 962. These plots 967 can become the basis of generating photometric data at point 968 for a customized light fixture.

Similarly, FIG. 10 shows a graph 1075 with two plots 1067 (plot 1067-1 and plot 1067-2). Plot 1067-1 is based on multiple data points 1069-1 (measured photometric data) of LED drive current 1061 (in milliamps per linear foot) versus light output 1062 (in lumens per linear foot). Plot 1067-2 is based on multiple data points 1069-2 (measured photometric data) of power 1063 (in watts per linear foot) versus light output 1062 (in lumens per linear foot). These plots 1067 can become the basis of generating photometric data at point 1068 for a customized light fixture.

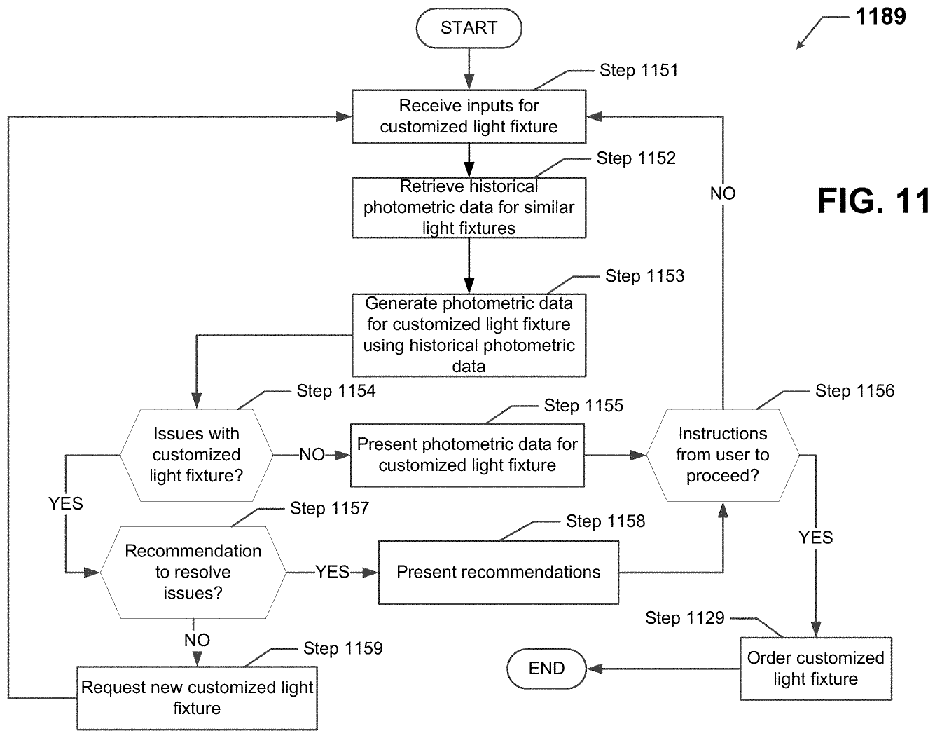

FIG. 11 shows a flowchart of a method 1189 for generating photometric data for a customized light fixture in accordance with certain example embodiments. While the various steps in this flowchart are presented and described sequentially, one of ordinary skill will appreciate that some or all of the steps may be executed in different orders, may be combined or omitted, and some or all of the steps may be executed in parallel. Further, in one or more of the example embodiments, one or more of the steps described below may be omitted, repeated, and/or performed in a different order.

In addition, a person of ordinary skill in the art will appreciate that additional steps not shown in FIG. 11 may be included in performing this method 1189. Accordingly, the specific arrangement of steps should not be construed as limiting the scope. Further, a particular computing device, as described, for example, in FIG. 3 above, can be used to perform one or more of the steps (or portions thereof) for the method 1189 described below in certain exemplary embodiments.

Referring now to FIGS. 1-11, the method 1100 begins at the START step and proceeds to step 1151, where inputs (e.g., inputs 471) for a customized light fixture are received. The inputs can be received by a photometric data tool 202 through an interface 242. The inputs can be provided by a user 250 (using a user system 255), one or more external systems 285, a network manager 280, and/or a sensor 260. The inputs set a number of parameters for a potential customized light fixture. The inputs can include, but are not limited to, a manufacturer, a model number, dimensions, lumen output, efficacy, power consumption, and type of light source.

In step 1152, historical photometric data for light fixtures that have at least one common characteristic with the customized light fixture is retrieved. The historical photometric data can be retrieved by the control engine 206 (on behalf of the photometric data generator 235) of the photometric data tool 202. The particular historical photometric data that is retrieved can be based on one or more of the inputs received in step 1151 by the control engine 206 of the photometric data tool 202. The control engine 206 of the photometric data tool 202 can use one or more protocols 232 to determine which particular historical photometric data to retrieve. The historical photometric data can be obtained from the storage repository 230 and/or from one or more of the external systems 285.

In step 1153, photometric data for the customized light fixture is generated by the photometric data generator 235 of the photometric data tool 202. The photometric data for the customized light fixture is customized and generated using the historical photometric data retrieved in step 1152. The photometric data generator 235 can use one or more algorithms 233 and/or protocols 232 to generate the photometric data for the customized light fixture. Other portions of the photometric data tool 202 that can assist in generating the photometric data of the customized light fixture can include, but are not limited to, the mapping module 211, the compliance module 237, the budgeting module 238, and the inventory module 239.

In step 1154, a determination is made as to whether any issues with the customized light fixture exist. This determination can be made by the photometric data tool 202 or any portions (e.g., the control engine 206, the mapping module 211, the compliance module 237, the budgeting module 238, the inventory module 239) thereof. An issue can include one or more of a wide array of problems that the customized light fixture can have. Examples of such problems can include, but are not limited to, a violation of a code or regulation, a lack of availability, an unapproved manufacturer of the customized light fixture, excessive price, insufficient expected longevity, and inferior expected performance. If there is an issue with the customized light fixture, the process proceeds to step 1157. If there is not an issue with the customized light fixture, the process proceeds to step 1155.

In step 1155, the photometric data for the customized light fixture is presented. The photometric data for the customized light fixture can be communicated by the photometric data tool 202 to the user system 255 of the user 250. In some cases, the photometric data for the customized light fixture can be presented using the interface 242 of the photometric data tool 202. The evaluation can include details about the photometric data for the customized light fixture. Such details can include, but are not limited to, vendors that can manufacture the customized light fixture, power requirements of the customized light fixture, light output of the customized light fixture, dimensions of the customized light fixture a detailed estimated budget, and a detailed schedule for delivering the customized light fixture.

In step 1156, a determination is made as to whether the user system 255 of the user 250 has provided instructions to proceed in ordering the customized light fixture. The user can provide instructions to proceed with the proposed customized light fixture and its installation using the interface 242 of the photometric data tool 202. If the user system 255 of the user 250 has provided instructions to proceed with ordering the customized light fixture, then the process proceeds to step 1129. If the user system 255 of the user 250 has not provided instructions to order the customized light fixture, then the process reverts to step 1151.

In step 1157, a determination is made as to whether one or more recommendations can be made to resolve the issues identified in step 1154. The recommendations can include one or more alternatives, determined by the photometric data tool 202, that can overcome the issues that were identified. In some cases, the photometric data tool 202 may not be able to make any recommendations, either because the customized light fixture is not able to comply with all of the inputs provided, or because resolving one issue causes another issue that cannot be resolved. If a recommendation can be made to resolve the issues, then the process proceeds to step 1158. If a recommendation cannot be made to resolve the issues, then the process proceeds to step 1159.

In step 1158, the recommendations are presented. In such a case, the recommendations can be presented by the photometric data tool 202 to the user system 255 of the user 250 using the interface 242. These recommendations can be as minimal as a statement suggesting those one or more alternatives, or as extensive as providing an entirely new proposed customized light fixture. Once the recommendations have been presented, the process proceeds to step 1156.

In step 1159, a request for a new customized light fixture is made. This request can be made by the photometric data tool 202 to the user system 255 of the user 250 using the interface 242 of the photometric data tool 202. Accompanying this request can be information as to the one or more issues raised in step 1154 and why those issues could not be resolved. Once this step 1159 is complete, the process reverts to step 1151.

In step 1129, the customized light fixture is ordered. In certain example embodiments, the installation of the customized light fixture is managed, at least in part, by the photometric data tool 202. For example, the photometric data tool 202 can order the customized light fixture, schedule delivery of the customized light fixture, schedule labor to install the customized light fixture, submit requests for proposals to manufacture the customized light fixture, draft and execute contracts, make payments, make any necessary adjustments during the installation process, apply for permits, contact and schedule inspectors, provide status reports to the user system 255 of the user 250, and manage testing of the customized light fixture. When step 1129 is completed, the method 1189 can proceed to the END step.

Example embodiments provide a number of benefits. Examples of such benefits include, but are not limited to, an accurate and real-time generation of photometric data for a customized light fixture based on a number of inputs provided by one or more sources (e.g., a user, an external source, a sensor). Example embodiments can also propose alternatives to the customized light fixture, order a customized light fixture, and assess compliance of the customized light fixture with applicable codes. Example embodiments can be used with new installations or with retrofitting of existing light fixtures. Example embodiments can provide a wide array of information, such as inventory information, scheduling information, pricing information, regulatory or code issues. Example embodiments can also identify problems with a proposed installation, generate alternatives, and evaluate those alternatives. Example embodiments can also provide project management services for the installation of a customized light fixture. Example embodiments can also provide an interactive interface with a user to receive calculated photometric data for a customized light fixture in real time.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

1. A photometric data tool comprising:
an interface; and
a controller coupled to the interface, wherein the controller is configured to:
receive a plurality of inputs, via the interface, wherein the plurality of inputs are associated with a proposed customized light fixture, wherein the plurality of inputs comprises a length of the customized light fixture;
retrieve historical photometric data for at least one previously-tested light fixture;
run, using at least one algorithm, the plurality of inputs, and the historical photometric data, a simulation of the proposed customized light fixture;
determine that results of the simulation meet performance criteria for the proposed customized light fixture; and
present photometric data for the proposed customized light fixture.

2. The photometric data tool of claim 1, wherein the controller is further configured to:
map the proposed customized light fixture at a point in a volume of space relative to other elements in the volume of space; and
evaluate an effectiveness of the proposed customized light fixture based on the photometric data.

3. The photometric data tool of claim 1, wherein the controller, when evaluating the plurality of inputs, is further configured to identify a problem with at least one input, identify at least one solution to resolve the problem, and present the at least one solution to the user.

4. The photometric data tool of claim 3, wherein the problem is associated with an insufficient amount of light emitted by the proposed customized light fixture.

5. The photometric data tool of claim 3, wherein the problem is associated with an amount of time to manufacture the proposed customized light fixture.

6. The photometric data tool of claim 3, wherein the problem is associated with a budgetary constraint.

7. The photometric data tool of claim 1, wherein the plurality of inputs further comprises at least one manufacturer capable of manufacturing the proposed customized light fixture.

8. The photometric data tool of claim 1, further comprising:
at least one sensor coupled to the controller, wherein the at least one sensor identifies a size and location of at least one object in a volume of space in which the proposed customized light fixture is intended.

9. The photometric data tool of claim 1, wherein the controller is further configured to:
save the photometric data as the historical photometric data for generating prospective photometric data for prospective customized light fixtures.

10. The photometric data tool of claim 1, further comprising:
an external system coupled to the controller, wherein the external system provides at least some of the historical photometric data.

11. The photometric data tool of claim 1, wherein the photometric data is generated by a photometric data generator using the at least one algorithm that is configured to extrapolate the photometric data based on the historical photometric data.

12. The photometric data tool of claim 1, further comprising:
a housing inside of which the controller is disposed and on which the interface is disposed.

13. The photometric data tool of claim 1, wherein the controller is part of a cloud-based application that is accessible on a user system.

14. The photometric data tool of claim 1, wherein at least one input of the plurality of inputs is selected by a user on the interface.

15. The photometric data tool of claim 1, wherein the photometric data is presented to a manufacturer to manufacture the proposed customized light fixture.

16. A non-transitory computer readable medium comprising computer readable program code embodied therein for a method for generating photometric data for a proposed customized light fixture using a photometric data tool, the method comprising:
receiving a plurality of inputs, via an interface of the photometric data tool, wherein the plurality of inputs are associated with the proposed customized light fixture, wherein the plurality of inputs comprises a length of the proposed customized light fixture;
retrieving, by a photometric data generator using the plurality of inputs, historical photometric data for at least one previously-tested light fixture;
running, using at least one algorithm, the plurality of inputs, and the historical photometric data, a simulation of the proposed customized light fixture;
determining that results of the simulation meet performance criteria for the proposed customized light fixture; and
presenting the photometric data for the proposed customized light fixture.

17. The non-transitory computer readable medium of claim 16, wherein the method further comprises:
mapping a volume of space in which the proposed customized light fixture is designed to be used, wherein the volume of space includes a plurality of objects disposed within the volume of space.

18. The non-transitory computer readable medium of claim 17, wherein the method further comprises:
identifying a problem with the proposed customized light fixture in the volume of space;
evaluating at least one alternative that addresses the problem; and
recommending at least one viable alternative to overcome the problem.

19. The non-transitory computer readable medium of claim 16, wherein the method further comprises:
determining whether the proposed customized light fixture complies with applicable code requirements for energy efficiency based on a geographic location at which the proposed customized light fixture is considered for installation.

20. The non-transitory computer readable medium of claim 16, wherein the method further comprises:
determining whether the proposed customized light fixture is within budgetary parameters.
